(19) United States
(12) Patent Application Publication
(10) Pub. No.: US 2012/0309648 A1
(43) Pub. Date: Dec. 6, 2012

(54) INTEGRATED MICROFLUIDICS FOR HIGHLY PARALLEL SCREENING OF CHEMICAL REACTIONS

(75) Inventors: Hsian-Rong Tseng, Los Angeles, CA (US); Jinyi Wang, Los Angeles, CA (US); Guodong Sui, Los Angeles, CA (US); Kym F. Faull, Los Angeles, CA (US); Yanju Wang, Los Angeles, CA (US); Wei-Yu Lin, Los Angeles, CA (US)

(73) Assignee: The Regents of the University of Calfornia, Oakland, CA (US)

(21) Appl. No.: 12/667,861

(22) PCT Filed: Jul. 7, 2008
(86) PCT No.: PCT/US08/08318

§ 371 Date: Jul. 2, 2010

Related U.S. Application Data
(60) Provisional application No. 60/929,654, filed on Jul. 6, 2007.

(51) Int. Cl. C40B 60/12; C40B 30/08

(52) U.S. Cl. 506/11; 506/39

(57) ABSTRACT

A microfluidic system has a microfluidic mixer and a sample storage component that is in fluid connection with the microfluidic mixer. The microfluidic mixer has a mixing section; a target molecule input section that is in fluid connection with the mixing section, the target molecule input section being suitable to provide a fluid into the mixing section that contains molecules to be targeted by chemical reactions; a first reagent input section that is in fluid connection with the mixing section, the first reagent input section being structured to selectively provide a first reagent selected from a plurality of reagents to test a chemical reaction with the target molecules; a second reagent input section that is in fluid connection with the mixing section, the second reagent input section being structured to selectively provide a second reagent selected from a plurality of reagents to test a chemical reaction with the target molecules and said first reagent; and a neutral fluid input section that is in selectable fluid connection with the sample storage component, the neutral fluid input section being structured to selectively provide a neutral fluid into the sample storage component between successive samples provided to the sample storage component to separate successive samples in a stratified arrangement.

### CROSS-REFERENCE OF RELATED APPLICATION

This application claims priority to U.S. Provisional Application No. 60/929,654 filed Jul. 6, 2007, the entire contents of which are hereby incorporated by reference.

The U.S. Government has a paid-up license in this invention and the right in limited circumstances to require the patent owner to license others on reasonable terms as provided for by the terms of Grant No. DEFG0206ER64294, awarded by the Department of Energy, and of Grant No. 1 U54 CA119347-01, awarded by the National Institutes of Health.

### BACKGROUND

1. Field of Invention

The current invention relates to microfluidic systems, devices and methods, and more particularly to microfluidic systems, devices and methods for parallel reactions for application in screening of chemical libraries.

2. Discussion of Related Art

Microfluidic devices can offer a variety of advantages over macroscopic reactors, such as reduced reagent consumption, high surface-to-volume ratios, and improved control over mass and heat transfer. (See, K. Jahnisch, V. Hessel, H. Lowe, M. Baerns, Angew. Chem. 2004, 116, 410-451; Angew. Chem. Int. Ed. Engl. 2004, 43, 406-446; P. Watts, S. J. Haswell, Chem. Soc. Rev. 2005, 34, 235-246; and G. Jas, A. Kirschning, Chem.-Eur. J. 2003, 9, 5708-5723.) Organic reactions that involve highly reactive intermediates can exhibit greater selectivities and specificities in reactions performed in microfluidic devices, e.g., microreactors, than in conventional macroscopic synthesis. (See, T. Kawaguchi, H. Miyata, K. Ataka, K. Mae, J. Yoshida, Angew. Chem. 2005, 117, 2465-2468; Angew. Chem. Int. Ed. Engl. 2005, 44, 2413-2416; and D. M. Ratner, E. R. Murphy, M. Jhunjhunwala, D. A. Snyder, K. F. Jensen, P. H. Seeberger, Chem. Commun. 2005, 578-580.) A microfluidic device can be integrated with a computer control system in order to perform complicated chemical and biological processes in an automated fashion.

However, past microfluidic devices were often limited in their ability to perform multistep syntheses. The individual steps of multistep syntheses can require the changing of solvents, reagents, and conditions.

Furthermore, past microfluidic devices often did not lend themselves to parallel syntheses. In a parallel synthesis, similar types of reactions can be performed using different combinations of reagents. For example, in biological or biochemical investigations, a researcher may need to carry out many different reactions simultaneously. For example, the fraction of the total number of reactions which yield desired product or indicate positive results may be low, so that a large number of reactions must be carried out. Such investigations include, for example, screening a large number of compounds for efficacy as a drug. Performing a large number of reactions sequentially can be prohibitively expensive, for example, in terms of researcher or technician time. Furthermore, if a long incubation or reaction time is required, too long a time may be required for the study. Performing a large number of reactions in parallel with conventional macroscopic laboratory equipment can be prohibitively expensive, for example, in terms of the apparatus required, overhead cost, or the quantities of reagents required. The use of an integrated microfluidic system prevents cross-contraindication between screening reactions which contains different components/chemicals or biological samples.

Even though the small length scales inherent in microfluidic devices could have provided a number of advantages, the small length scales posed challenges for certain operations. For example, the small length scales and associated low fluid velocities inherent in the operation of past microfluidic devices resulted in a low Reynolds number for fluid flows through the devices. That is, the fluid flows were often in the laminar regime. Because turbulent flow was not achieved, mixing was often poor, and the inhomogeneity of the fluids caused poor results or complicated the interpretation of data.

Therefore, there is a need for microfluidic devices with which multistep syntheses can be performed in parallel for large numbers of combinations, individual steps can be isolated, and good mixing of reagents in fluid combinations can be obtained.

### SUMMARY

A microfluidic system according to an embodiment of the current invention has a microfluidic mixer and a sample storage component that is in fluid connection with the microfluidic mixer. The microfluidic mixer has a mixing section; a target molecule input section that is in fluid connection with the mixing section, the target molecule input section being suitable to provide a fluid into the mixing section that contains molecules to be targeted by chemical reactions; a first reagent input section that is in fluid connection with the mixing section, the first reagent input section being structured to selectively provide a first reagent selected from a plurality of reagents to test a chemical reaction with the target molecules; a second reagent input section that is in fluid connection with the mixing section, the second reagent input section being structured to selectively provide a second reagent selected from a plurality of reagents to test a chemical reaction with the target molecules and said first reagent; and a neutral fluid input section that is in selectable fluid connection with the sample storage component, the neutral fluid input section being structured to selectively provide a neutral fluid into the sample storage component between successive samples provided to the sample storage component to separate successive samples in a stratified arrangement.

A method of identifying molecules that have a predetermined reaction with a target molecule according to an embodiment of the current invention includes providing a fluid containing target molecules in a microfluidic mixer, providing a first reagent from a plurality of available first reagents in said microfluidic mixer along with the target molecules, providing a second reagent from a plurality of available second reagents in the microfluidic mixer along with the target molecules and the first reagent, mixing the first reagent, the second reagent and the fluid containing the target molecules to obtain an at least partially mixed sample, directing the at least partially mixed sample into a sample storage component, directing a neutral fluid into the sample storage component after the directing the at least partially mixed sample into the sample storage component has been completed to provide a separation layer for protecting the at least partially mixed sample from contamination from subsequent samples to be directed into the sample storage component.

### BRIEF DESCRIPTION OF THE DRAWINGS

Further objectives and advantages will become apparent from a consideration of the description, drawings, and examples.

FIG. 1 is a schematic illustration of a microfluidic device according an embodiment of the current invention.

FIG. 2A is a schematic representation of a microfluidic device used for the parallel screening of an in situ click chemistry library according to an embodiment of the current invention.

FIG. 2B is an optical image of an actual device according to an embodiment of the current invention.

FIGS. 3A-3D are schematic diagrams that illustrate four sequential processes for preparing an individual in situ click chemistry mixture in the microfluidic device according to an embodiment of the current invention.

FIG. 4 is a summary of in situ click chemistry screening results between acetylene 1 and azides 2-21 obtained using the microfluidic device according to an embodiment of the current invention and (in parentheses) 96-well microtiter plates.

FIG. 5 presents the results of LC/MS analysis of in situ click chemistry reactions between acetylene 1 and azide 2. a) Triazole product obtained through Cu¹-catalyzed reaction; b) microchip-based reaction performed in the presence of bCAII (bovine carbonic anhydrase 11); c) microchip-based reaction performed in the presence of both bCAII and inhibitor 22, and d) microchip-based reaction performed in the absence of bCAII; e) reaction performed in a 96-well microtiter plate in the presence of bCAII.

FIG. 6 presents the results of LC/MS analysis of in situ click chemistry reactions between acetylene 1 and azide 3. a) Triazole product; b) microchip-based reaction performed in the presence of bCAII, c) microchip-based reaction performed in the presence of both bCAII and inhibitor 22, and d) microchip-based reaction performed in the absence of bCAII.

FIG. 7 is a schematic illustration of a microfluidic system according to another embodiment of the current invention.

FIGS. 8A and 8B contrast examples of microfluidic devices according to two embodiments of the current invention. An example of the microfluidic device of FIG. 7 is shown in FIG. 8B.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited herein are incorporated by reference as if each had been individually incorporated. In particular, application PCT/US2007/005248 assigned to the same owner as this application is hereby incorporated by reference herein in its entirety.

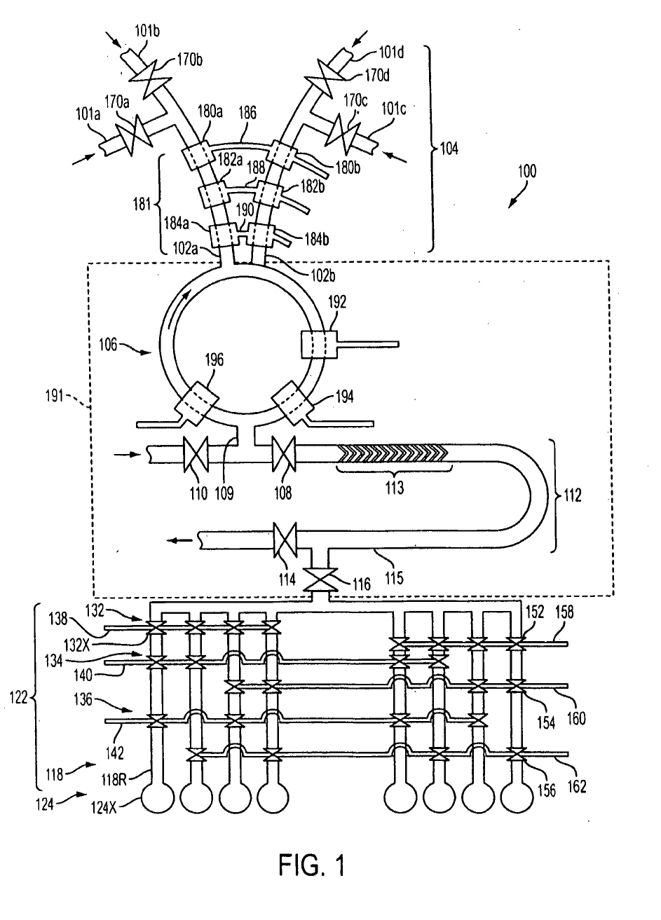

An embodiment of a microfluidic device according to the current invention is illustrated schematically in FIG. 1. The device can be implemented by a soft lithography technique. For example, a layer of polydimethylsiloxane (PDMS) can be applied to a surface. The layer can be coated with resist, exposed to a light pattern and etched to create fluid channels in a predefined pattern. Successive steps of coating, exposing, and etching can be used to create fluid channels on several superimposed levels. For example, a first level of fluid channels can be designed to guide the flow of reagents intended for synthesis of the compounds of interest. A second level of fluid channels can be designed to transmit pressure in control lines used to actuate pumps and/or valves used to transport and control the reagents flowing in the first level. The first level and the second level can be separated by a thin film of PDMS. The separating layer can act to isolate reagents in the first level from the fluid in the control lines in the second level. Furthermore, the separating layer of PDMS can act as a component of microscale devices such as pumps and valves. For example, pressure applied on a control line in the second level may act to deform the separating layer above a fluid channel in the first level, and thereby block the flow of reagent through the fluid channel; i.e., the separating layer may act as a valve.

In one embodiment, the microfluidic device 100 illustrated in FIG. 1 includes two or more fluid sources (101a, 101b, 101c, 101d). Each fluid source (101a, 101b, 101c, 101d) can contain a different chemical reagent. The microfluidic device 100 includes two or more fluid input microchannels (102a and 102b). The microfluidic device 100 is not limited to only two input microchannels (102a and 102b). For example, it can include three or more fluid input microchannels. Valves (170a, 170b, 170c, 170d) regulate the flow of fluid from a fluid source (101a, 101b, 101c, 101d) into a fluid input microchannel (102a and 102b).

In one embodiment, the fluid input microchannel (102a and 102b) includes a metering pump 181. The metering pump includes upstream pump valves (180a and 180b), midstream pump valves (182a and 182b), and downstream pump valves (184a and 184b). The upstream pump valve 180a associated with the fluid input microchannel 102a is connected to the other upstream pump valve 180b associated with the other fluid input microchannel 102b by an upstream control line 186; the midstream pump valve 182a is connected to the other midstream pump valve 182b by a midstream control line 188; and the downstream pump valve 184a is connected to the other downstream pump valve 184b by a downstream control line 190.

The microfluidic device 100 can include a mixing section 191 fluidly connected to the two or more fluid input microchannels (102a and 102b).

In one embodiment, the mixing section 191 includes a rotary mixer 106. The rotary mixer 106 is fluidly connected to the fluid input microchannels (102a and 102b). The rotary mixer 106 includes a rotary mixer pump. The rotary mixer pump in this embodiment includes at least three pump valves. The rotary mixer pump includes a first pump valve 192, a second pump valve 194, and a third pump valve 196. The rotary mixer 106 is fluidly connected to a rotary mixer output microchannel 109. The rotary mixer output microchannel 109 can include a rotary mixer output valve 108 and a purge inlet valve 110.

The rotary mixer 106 can have a volume within the range of from about 5 mL (nanoliters) to about 12500 mL, can have a volume within the range of from about 25 mL to about 2500 mL, and can have a volume of about 250 mL.

In one embodiment, the mixing section includes a chaotic mixer 112. The chaotic mixer 112 includes a fluid channel 113 having at least one protrusion, which induces chaotic advection to induce mixing of fluid traveling through the channel. The chaotic mixer 112 is fluidly connected to a chaotic mixer output microchannel 115. The chaotic mixer output microchannel 115 includes a chaotic mixer output valve 116 and a purge outlet valve 114.

In one embodiment, the rotary mixer output microchannel 109 is fluidly connected to the chaotic mixer 112.

The microfluidic device 100 can include a plurality of microvessels 124, e.g., microvessel 124x, each microvessel 124 being in selective fluid connection with the mixing section 191.

In one embodiment, the microfluidic device 100 includes a microfluidic multiplexer 122. The microfluidic multiplexer 122 is fluidly connected to the mixing section 191 and is fluidly connected to the plurality of microvessels 124. The microfluidic multiplexer 122 serves as the selective fluid connection of each microvessel 124 with the mixing section 191.

In one embodiment, the microfluidic multiplexer 122 includes two or more multiplexer microchannels 118, e.g., multiplexer, microchannel 118x. Each multiplexer microchannel 118 is fluidly connected with one microvessel 124, and each multiplexer microchannel 118 comprises at least one multiplexer valve (132, 134, 136, 152, 154, 156), e.g., multiplexer valve 132x. The microfluidic multiplexer 122 comprises a plurality of multiplexer control lines (138, 140, 142, 158, 160, 162) in connection with the multiplexer valves (132, 134, 136, 152, 154, 156). The number of multiplexer microchannels 118 is greater than or equal to two plus the number of multiplexer control lines (138, 140, 142, 158, 160, 162).

In one embodiment, the number of control lines (NCL) (138, 140, 142, 158, 160, 162) in the microfluidic multiplexer 122 is even and six or more. The number of multiplexer microchannels 118 is less than or equal to 2^{NCL/2}.

In one embodiment, each multiplexer microchannel 118 includes NCL/2 multiplexer valves (132, 134, 136, 152, 154, 156), and each multiplexer valve (132, 134, 136, 152, 154, 156) is connected to a multiplexer control line (138, 140, 142, 158, 160, 162). Each control line is connected to 2^{(NCL/2-1)} multiplexer valves (132, 134, 136, 152, 154, 156), each multiplexer valve (132, 134, 136, 152, 154, 156) being on a separate multiplexer microchannel 118. The set of multiplexer control lines (138, 140, 142, 158, 160, 162) to which the multiplexer valves (132, 134, 136, 152, 154, 156) on a multiplexer microchannel 118 are connected are not the same as the set of multiplexer control lines (138, 140, 142, 158, 160, 162) to which the multiplexer valves (132, 134, 136, 152, 154, 156) on any other microchannel 118 are connected.

The multiplexer control lines (138, 140, 142, 158, 160, 162) of the microfluidic multiplexer 122 can contain a fluid having a pressure. By applying a pressure to the fluid, the state of the multiplexer valves (132, 134, 136, 152, 154, 156) to which the multiplexer control line (138, 140, 142, 158, 160, 162) is connected can be changed. For example, by applying pressure, the state of the multiplexer valves (132, 134, 136, 152, 154, 156) can be changed from open to closed, so that fluid cannot pass through the microchannel 118. As another example, by releasing pressure, the state of the multiplexer valves (132, 134, 136, 152, 154, 156) can be changed from closed to open, so that fluid can pass through the microchannel 118. The multiplexer control lines (138, 140, 142, 158, 160, 162) of the microfluidic multiplexer 122 can contain a liquid as the fluid, and the control lines can be termed hydraulic control lines. The control lines of the microfluidic multiplexer can contain a gas as the fluid, and the control lines can be termed pneumatic control lines.

One embodiment of a method according to the invention includes the following. The user (or a control device, e.g., a computer) can independently select quantities of two or more reagents. The user can independently select quantities of three or more reagents. The mixing section of the microfluidic device 100 mixes the selected reagents to form a test mixture. The user (or a control unit, such as a computer) then selects a microvessel 124 to which the test mixture is to be transferred. The microfluidic device 100 conveys the test mixture to the selected microvessel 124. The steps of independently selecting quantities of at least two reagents, mixing the reagents, selecting a microvessel 124, and conveying the test mixture can be repeated until a predetermined number of microvessels 124 has been selected.

The test mixture can have a volume of from about 0.1 μL to about 80 μL, can have a volume of from about 1 μL to about 16 μL, and can have a volume of about 4 μL.

The user can allow test mixtures in each selected microvessel 124 to react for a predetermined period of time. The user can extract a test mixture from a selected microvessel 124, and can analyze the extracted test mixture.

In one embodiment, conveying the test mixture to the selected microvessel 124 includes the following. The user (or a control unit, such as a computer) identifies the microchannel 118 in fluid connection with the selected microvessel. The user identifies the multiplexer valves (132, 134, 136, 152, 154, 156) associated with the identified microchannel. The user identifies the multiplexer control lines (138, 140, 142, 158, 160, 162) associated with the identified multiplexer valves. The user then sets the state of the identified multiplexer control lines, e.g., the user can deactuate the identified multiplexer control lines to cause all identified multiplexer valves to open. Deactuating the identified multiplexer control lines can include relieving pressure applied to a fluid in the identified multiplexer control lines. The user can then set the state of the other, non-identified multiplexer control lines, e.g., the user can actuate the other, non-identified multiplexer control lines, in order to cause all non-identified multiplexer valves to close. Actuating the non-identified multiplexer control lines can include applying or maintaining pressure on a fluid in the non-identified multiplexer control lines.

In one embodiment, the user (or a control unit, such as a computer), by deactuating identified multiplexer control lines and actuating non-identified multiplexer control lines, causes no non-identified microchannel to have all of the multiplexer valves associated with the non-identified microchannel being open.

In one embodiment, conveying the test mixture to the selected microvessel 124 can include applying pressure to the text mixture. Conveying the test mixture to the selected microvessel 124 can include applying pressure to a fluid in contact with the test mixture.

In one embodiment, mixing the input reagents to form a test mixture can include opening and closing valves in a rotary mixer 106 in a predetermined order to drive the input reagents in a clockwise or in a counterclockwise direction by peristaltic action. For example, the user (or a control unit, such as a computer) can (a) close a first valve 192 and open a second valve 194 and a third valve 196 of a rotary mixer 106, (b) close the second valve 194 of the rotary mixer 106 to force fluid away from the first valve 192, and (c) close the third valve 196 and open the first valve 192 and second valve 194 of the rotary mixer 106. The user (or a control unit, such as a computer) can repeat steps (a), (b), and (c) as long as desired, for example, until the test mixture has a predetermined length scale of homogeneity.

A predetermined length scale of homogeneity arises from considering two cubes of fluid. The length of edges of the cubes for which the average concentration of each reagent in a cube varies from the average concentration of the reagent in the other cube by no more than a predetermined percentage, e.g., 10%, regardless of the location of each cube in the volume of fluid, and for which a decrease in the length of the edges would result in an increase in variation of the average concentration over this predetermined percentage, is the length scale of homogeneity in the fluid.

The test mixture can be conveyed through the chaotic mixer 112 and to the microfluidic multiplexer 122 by opening the purge inlet valve 110 and applying pressure to drive a bulk fluid through the purge inlet valve 110 toward the chaotic mixer 112. The bulk fluid can exert a pressure on the test mixture to drive the test mixture through the chaotic mixer. The bulk fluid can exert a pressure on the test mixture to drive the test mixture to and through the microfluidic multiplexer 122.

Although the embodiments described above have hydraulic and/or pneumatic valves, broad concepts of the invention are not limited to only such structures. Furthermore, microfluidic devices according to the current invention are not limited to only PDMS structures as described in the above embodiments.

A microfluidic device such as in the embodiments described in this specification can be integrated with analytical instruments. For example, a reaction product from a microfluidic device can be directed to an analytical instrument such as LC/MS (liquid chromatography/mass spectrometry) instruments. (See, W. G. Lewis, L. G. Green, F. Grynszpan, Z. Radic, P. R. Carlier, P. Taylor, M. G. Finn, K. B. Sharpless, Angew. Chem. 2002, 114, 1095-1099; Angew. Chem. Int. Ed. Engl. 2002, 41, 1053-1057; V. D. Bock, H. Hiemstra, J. H. van Maarseveen, Eur. J. Org. Chem. 2005, 51-68; and V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) Integrated microfluidics can provide an excellent experimental platform, for example, for the screening of chemical compounds, such as in the identification of pharmaceutically active compounds, because it enables parallelization and automation. The miniaturization associated with integrated microfluidics allows economical use of reagents, such as target proteins and expensive chemical compounds.

### EXAMPLES

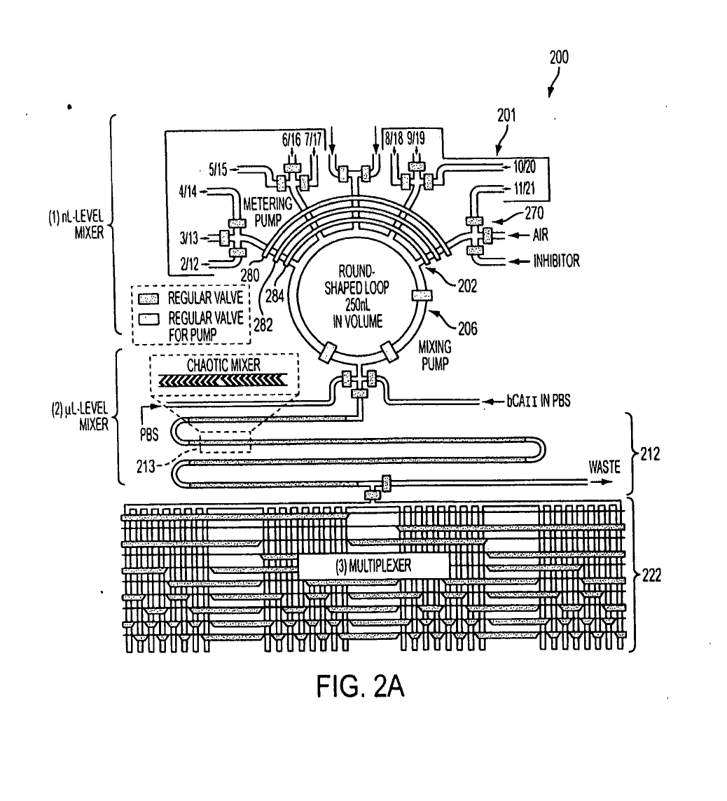

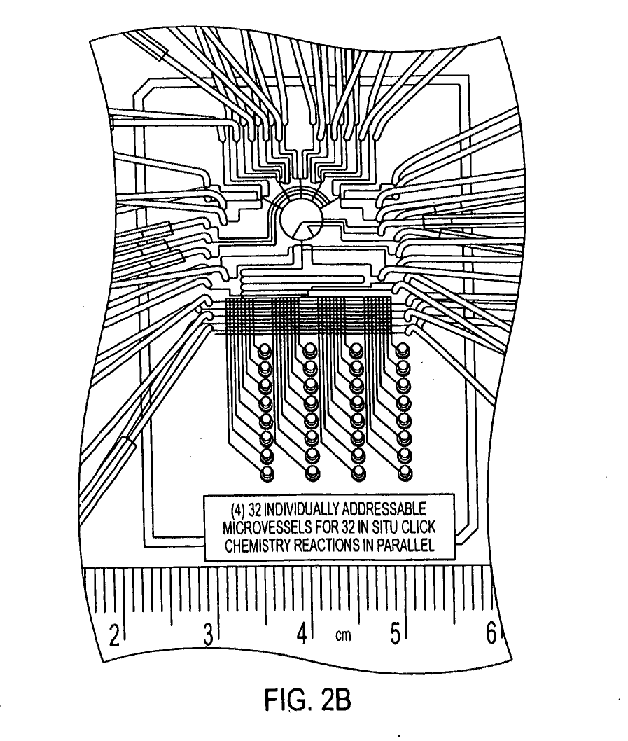

A schematic of a microfluidic device according to some embodiments of the current invention is illustrated in FIG. 2A. A more detailed view of this microfluidic device is presented in FIG. 2B. With this microfluidic device, 32 different mixtures of reagents can be allowed to react simultaneously, i.e., in parallel. However, a much greater number of different mixtures of reagents can be allowed to react simultaneously with other embodiments of the current invention.

The microfluidic device in this example can produce test mixtures having a volume of about 4 μL. For example, in situ click chemical reactions can be investigated with such test mixtures. (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) For example, a 4 μL volume test mixture can include 19 μg of an enzyme, 2.4 nmol of an acetylene compound, and 3.6 nmol of an azide compound.

In contrast, in a conventional approach, test mixtures of in situ click chemistry reactants have a volume of 100 μL, and contain 94 μg of enzyme, 6 nmol of an acetylene and 40 nmol of an azide. This illustrates that a microfluidic device according to the present invention requires smaller quantities of reagents than a conventional approach. The conservation of reagents by the microfluidic device is of advantage, for example, when the reagents are expensive to buy or difficult to produce.

The microfluidic device 200 according to an embodiment of the current invention (FIGS. 2A and 2B) comprises the following. A nanoliter (nL)-level rotary mixer 206 with a total volume of about 250 mL is shown in FIG. 2A. This round-shaped loop, along with associated fluid input microchannels 202, pump valves (280, 282, 284), valves 270 and fluid sources 201, can selectively sample, precisely meter, and mix nanoliter quantities of reagents. (See, M. A. Unger, H. P. Chou, T. Thorsen, A. Scherer, S. R. Quake, Science 2000, 288, 113-116.) For example, in the in situ click chemistry experiment performed, 80 mL of an acetylene compound (acetylene 1), 120 mL of an azide compound (azides 1-11 or 12-21), and up to 40 mL of an inhibitor (inhibitor 22) were mixed for each test mixture.

A microliter (μL)-level chaotic mixer 212 for combining the nanoliter quantity of mixed reagents from the rotary mixer 206 with μL-amounts of a bCAII (bovine carbonic anhydrase II) solution in phosphate buffer saline (PBS, pH 7.4) is shown in FIG. 2A. (See, A. D. Stroock, S. K. W. Dertinger, A. Ajdari, 1. Mezic, H. A. Stone, G. M. Whitesides, Science 2002, 295, 647-651.) A homogenous reaction mixture was generated via chaotic mixing inside a 37.8-mm long microchannel 213 containing embedded micropatterns, that is, containing protrusions, which induced chaotic advection to facilitate mixing within the relatively short microchannel. (See, A. D. Stroock, S. K. W. Dertinger, A. Ajdari, I. Mezic, H. A. Stone, G. M. Whitesides, Science 2002, 295, 647-651.) The micropatterns were 20% longer than theoretically required to ensure efficient mixing. (31.5 mm long micropatterns are required to achieve efficient mixing in 200 μm wide microchannels. This length was obtained according to the theoretical model described in A. D. Stroock, S. K. W. Dertinger, A. Ajdari, 1. Mezic, H. A. Stone, G. M. Whitesides, Science 2002, 295, 647-651.)

A microfluidic multiplexer 222 served to guide each test mixture into one of 32 individually addressable microvessels for storing the test mixtures. (See, T. Thorsen, S. J. Maerkl, S. R. Quake, Science 2002, 298, 580-584.) The microvessels had the form of cylindrical wells, which were 1.3 mm in diameter and 6 mm in depth (and, thus, about 8 μL in volume).

A computer-controlled interface was used to program multiple steps of an operation cycle to prepare each test mixture. Thirty-two such operation cycles were compiled in sequence to create an entire library of 32 test mixtures (one for each microvessel) within the microfluidic device in a run.

### Operation Cycle

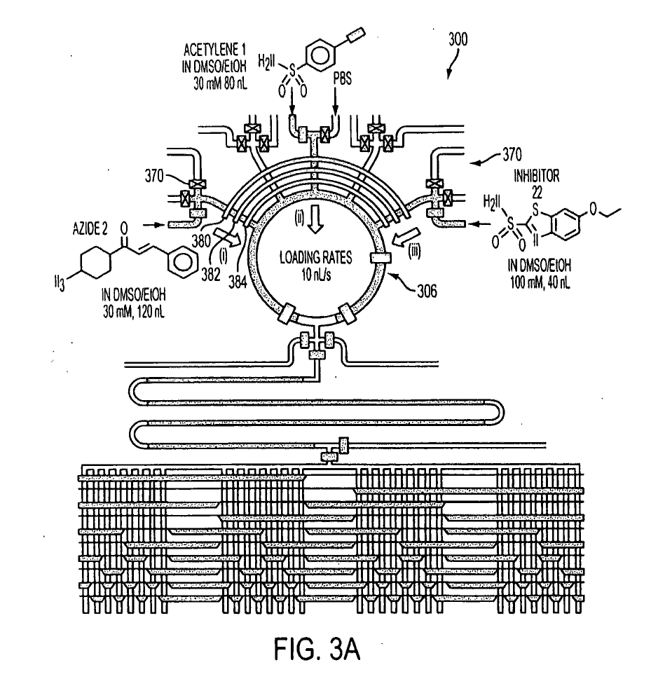

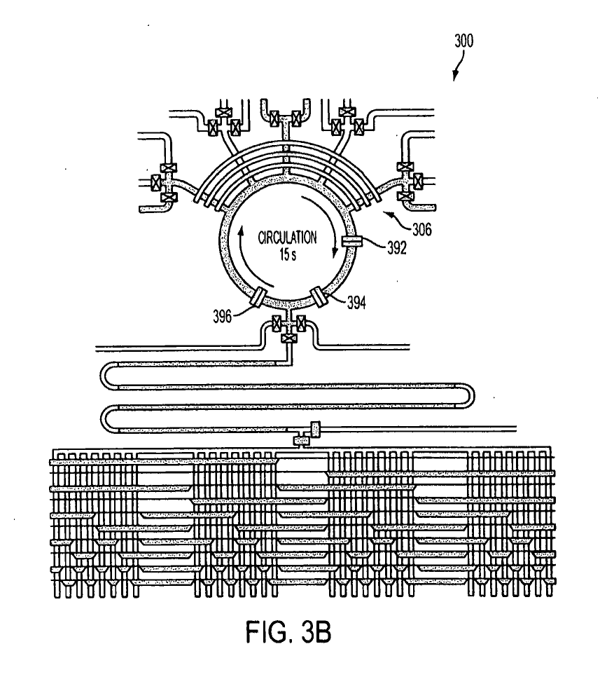

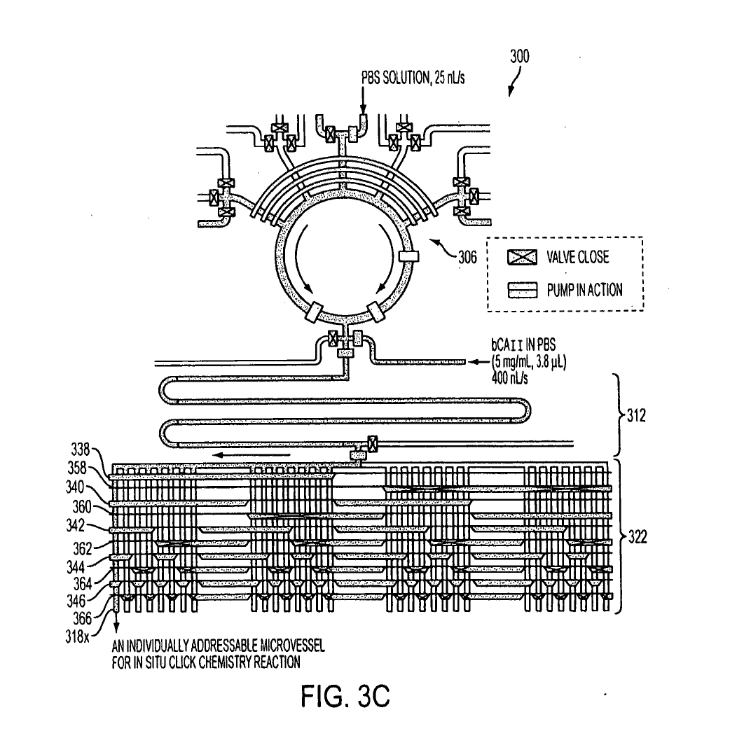

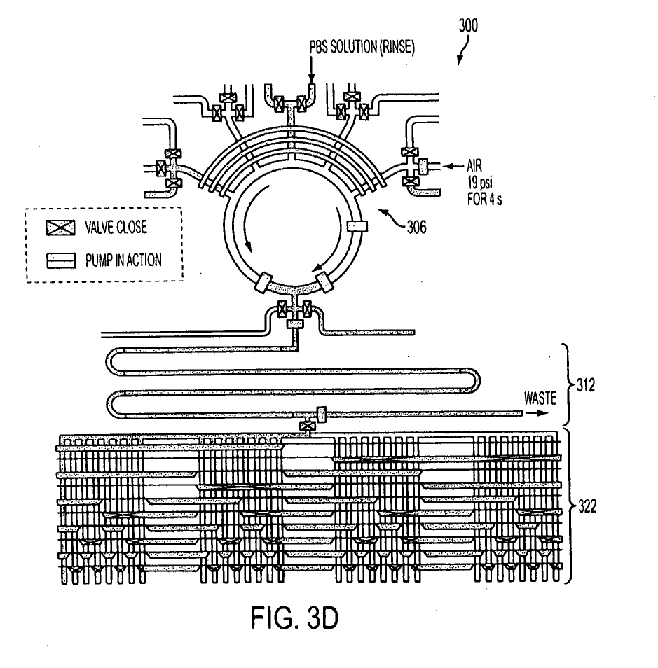

A method of producing each test mixture in a microfluidic device 300 is illustrated in FIGS. 3A-3D. FIG. 3A shows that metering pumps 380, 382, 384 were used to introduce an azide 2, an acetylene 1, and an inhibitor 22 into the rotary mixer 306 sequentially, at a flow rate of about 10 mL/sec. The appropriate configuration of the valves 370 is shown (closed valves are designated with an X). PBS solution was then introduced by the metering pumps 380, 382, 384 to fill the round-shaped loop of the rotary mixer 306 completely.

FIG. 3B shows that the reagent solutions were then mixed for 15 seconds in the nL-scale rotary mixer 306 (circulation rate: ca 18 cycle/min) by using the mixing pump. The mixing pump was formed of valves 392, 394, 396 which were cycled open and closed as described above to cause a peristaltic pumping action of the reagent solutions around the loop of the rotary mixer 306.

FIG. 3C shows that the reagent solutions in the rotary mixer 306 were then forced out of the rotary mixer 306 and into the chaotic mixer 312 by introducing a PBS solution into the rotary mixer 306 at a flow rate of about 25 nL/sec. At the same time, a total of 3.8 μL of bCAII solution was introduced at a flow rate of about 400 mL/sec into the chaotic mixer 312. The test mixture was thus induced to flow through the chaotic mixer 312 and into the microfluidic multiplexer 322. The multiplexer control lines 338, 340, 342, 344, and 346 were deactuated so that all multiplexer valves associated with the microchannel 318x were open and the test mixture could flow through microchannel 318x into the microvessel fluidly connected to the end of the microchannel 318x (not shown). All of the other multiplexer control lines 358, 360, 362, 364, and 366 were actuated to close multiplexer valves so that no other microchannel had all its associated multiplexer valves open, and the test mixture could not flow into any other microvessel.

FIG. 3D shows that the channels of the rotary mixer 306, the chaotic mixer 312 and the microfluidic multiplexer 322 through which the test mixture had passed in the steps illustrated by FIGS. 3A-3C and discussed above were then rinsed by introducing 2 μL of a PBS solution and introducing an air flow purge. This prevented cross-contamination between an operation cycle and the subsequent operation cycle.

The operation cycle illustrated in FIGS. 3A-3D and discussed above was repeated, but with subsequently different settings of the multiplexer control lines 338, 340, 342, 344, 346, 358, 360, 362, 364, and 366, in order to select different microvessels, a total of 32 times. Completion of the 32 operation cycles to fill each of the microvessels with a different test mixture took approximately 30 minutes (about 57 sec/cycle). After each of the 32 microvessels were filled, the microfluidic device 300 was placed into a moisture-regulated incubator at 37° C. for 40 h to complete the reactions of the test mixtures in the microvessels. Thus, 32 different reactions proceeded simultaneously over a time interval much shorter than if the 32 reactions had been carried out sequentially, one after the other.

After incubation, the reacted test mixtures were collected from the microvessels. Each microvessel was rinsed with MeOH (5 μL×3), and the rinsing solution for a microvessel was combined with the original reacted test mixture in the microvessel. LC/MS analysis was performed on each of the test mixtures.

### Chemistry

The in situ click chemistry investigated with the microfluidic device according to some embodiments of the current invention is a target-guided synthesis method for discovering high-affinity protein ligands by assembling complementary azide and acetylene building blocks inside the target's binding pockets through 1,3-dipolar cycloaddition. (See, D. Rideout, Science 1986, 233, 561-563; I. Hue, J. M. Lehn, Proc. Natl. Acad. Sci. U.S.A. 1997, 94, 2106-2110; J. M. Lehn, A. V. Eliseev, Science 2001, 291, 2331-2332; 0. Ramstrom, J. M. Lehn, Nat. Rev. Drug Discovery 2002, 1, 26-36; D. A. Erlanson, A. C. Braisted, D. R. Raphael, M. Randal, R. M. Stroud, E. M. Gordon, J. A. Wells, Proc. Natl. Acad. Sci. U.S.A. 2000, 97, 9367-9372; K. C. Nicolaou, R. Hughes, S. Y. Cho, N. Winssinger, C. Smethurst, H. Labischinski, R. Endermann, Angew. Chem. 2000, 112, 3981-3986; Angew. Chem. Int. Ed. Engl. 2000, 39, 3823-3828; W. G. Lewis, L. G. Green, F. Grynszpan, Z. Radic, P. R. Carlier, P. Taylor, M. G. Finn, K. B. Sharpless, Angew. Chem. 2002, 114, 1095-1099; Angew. Chem. Int. Ed. Engl. 2002, 41, 1053-1057; V. D. Bock, H. Hiemstra, J. H. van Maarseveen, Eur. J. Org. Chem. 2005, 51-68; V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120; and A. Krasinski, Z. Radic, R. Manetsch, J. Raushel, P. Taylor, K. B. Sharpless, H. C. Kolb, J. Am. Chem. Soc. 2005, 127, 6686-6692.)

The resulting ligands display much higher binding affinities to the target than the individual fragments, and the hit identification is as simple as detecting product formation using analytical instruments, such as LC/MS. (See W. G. Lewis, L. G. Green, F. Grynszpan, Z. Radic, P. R. Carlier, P. Taylor, M. G. Finn, K. B. Sharpless, Angew. Chem. 2002, 114, 1095-1099; Angew. Chem. Int. Ed. Engl. 2002, 41, 1053-1057; and V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) The bCAII click chemistry system was used in the experiments. (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) Acetylenic benzenesulfonamide (1) (K_{d}=37±6 nM) was used as the reactive scaffold (“anchor molecule”) for screening a library of 20 complementary azides 2-21. In control experiments, the active site inhibitor, ethoxazolamide (22) (K_{d}=0.15±0.03 nM), was utilized to suppress the in situ click chemistry reactions.

In order to determine appropriate reaction conditions for this microfluidics-based in situ click chemistry screening, click reactions between acetylene 1 and azide 2 were performed under different reaction conditions to ensure minimum use of enzyme and reagents and yet generate reliable and reproducible LC/MS signals for hit identification. (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) The microfluidic screening platform described in this paper, utilizes a reaction volume of about 4 μL, corresponding to 19 μg of enzyme, 2.4 nmol of the acetylene, and 3.6 nmol of the azide for each reaction, instead of the 100-μL reaction mixture (containing 94 μg of the enzyme, 6 nmol of the acetylene and 40 nmol of the azide) employed in the conventional approach. Overall, a 2- to 12-fold sample economy was achieved.

In situ click chemistry screening of 10 different binary azide/acetylene combinations was performed in parallel by preparing 32 individual reaction mixtures of the following types: (i) 10 in situ click chemistry reactions between acetylene 1 and 10 azides in the presence of bCAII; (ii) 10 control reactions that are performed as in (i), but in the presence of inhibitor 22, to confirm the active-site specificity of the in situ click chemistry reactions; (iii) 10 thermal click chemistry reactions performed as in (i), but in the absence of bCAII, to monitor the enzyme-independent reactions; and (iv) a blank PBS solution containing only bCAII and a PBS solution utilized for the channel washing. Under these conditions, the entire library of twenty azides 2-21 was screened in two batches, first azides 2-11, then 12-21. A DMSO/EtOH mixture (V_{DMSO}/V_{EtOH}=1:4) was utilized as solvent for all reagents, since it does not damage the PDMS-based microchannels or affect the performance of the embedded valves and pumps. (See, J. N. Lee, C. Park, G. M. Whitesides, Anal. Chem. 2003, 75, 6544-6554.) Each in situ click chemistry reaction employed an 80 mL solution of acetylene 1 (30 mM, 2.4 nmol), a 120 mL solution of one of the azides 2-21 (30 mM, 3.6 nmol), and a 3.8 μL PBS solution of bCAII (5 mg/mL, 19 μg). For the control reactions, an additional 40 mL solution of inhibitor 22 (100 mM, 4 nmol) was added. In the thermal reactions, the bCAII solutions were replaced with blank PBS.

### Results

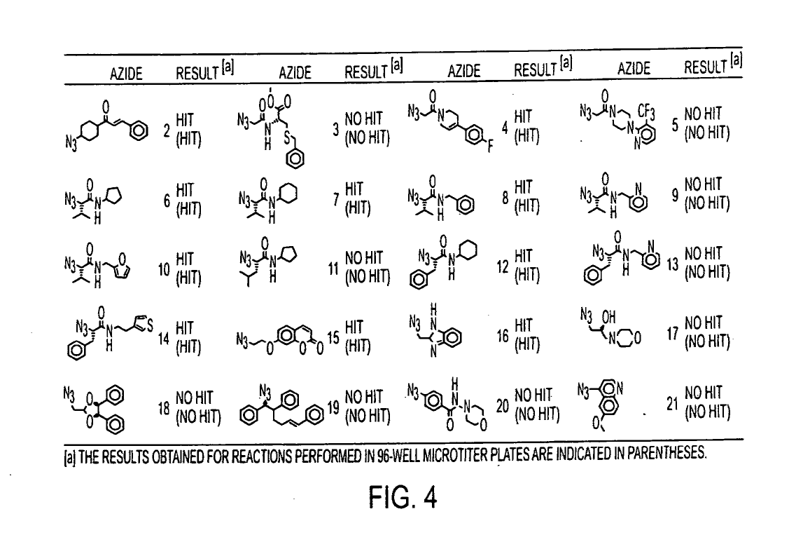

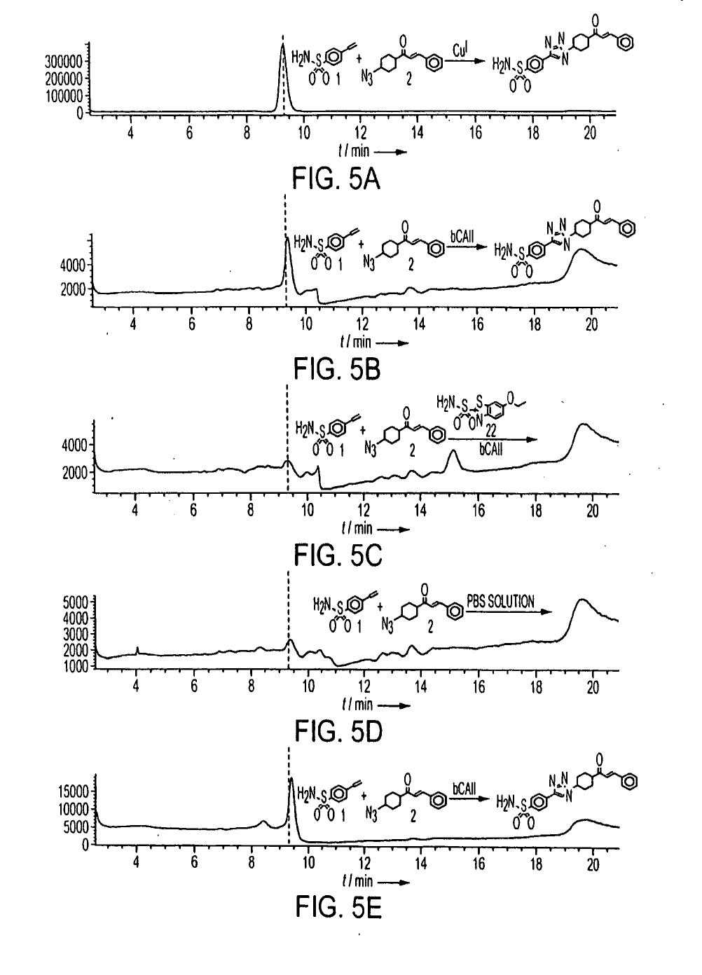

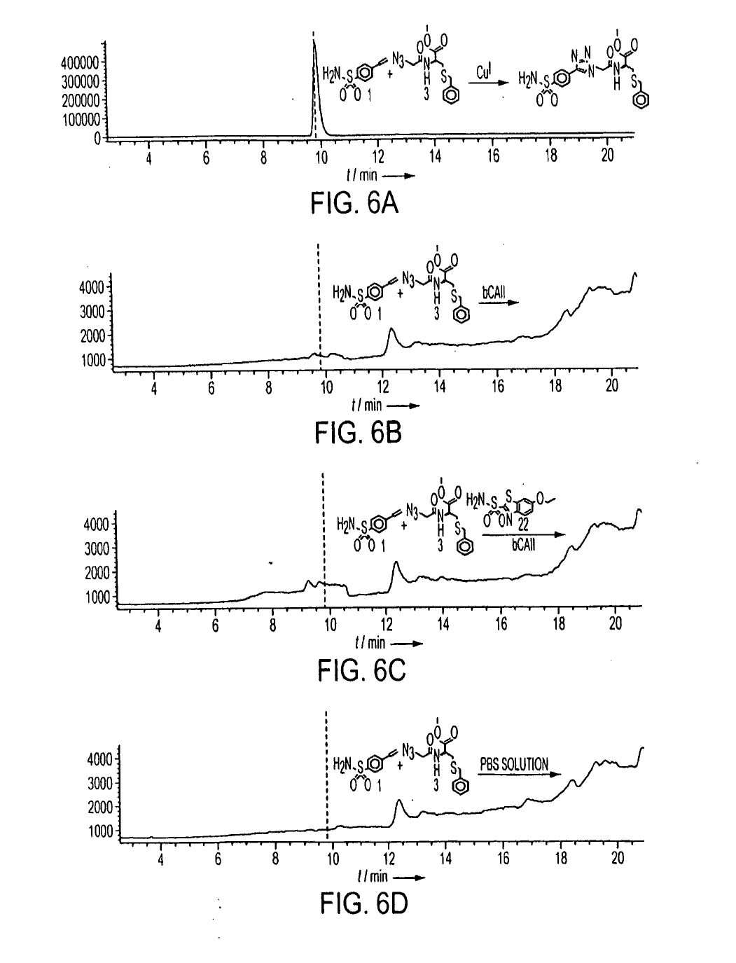

For reference purposes, the 1,4-disubstituted (“anti”) triazoles were prepared separately from the corresponding Cu¹-catalyzed reactions. (See, V. P. Mocharla, B. Colasson, L. V. Lee, S. Roper, K. B. Sharpless, C. H. Wong, H. C. Kolb, Angew. Chen. 2005, 117, 118-122; Angew. Chem. Int. Ed. Engl. 2005, 44, 116-120.) The LC/MS analyses indicated that 10 out of the 20 reaction combinations had led to the formation of triazole products in the presence of bCAII. For comparison, all 20 in situ click chemistry reactions were also performed in 96-well microtiter plates. FIG. 4 summarizes the results of the in situ click chemistry screening between acetylene 1 and twenty azides (2-21) in the new microfluidics format and the conventional system, revealing a very similar outcome (the results obtained for reactions performed in 96-well microtiter plates are indicated in parentheses). (See, V. P. Mocharla, B. Colasson, L. V. Lee, S. Roper, K. B. Sharpless, C. H. Wong, H. C. Kolb, Angew. Chem. 2005, 117, 118-122; Angew. Chem. Int. Ed. Engl. 2005, 44, 116-120.) FIG. 5 illustrates the LC/MS analyses of a positive hit identification obtained for the screening reaction between acetylene 1 and azide 2 and its control studies, and FIG. 6 shows those obtained for a negative hit identification between acetylene 1 and azide 3.

### Further Embodiments

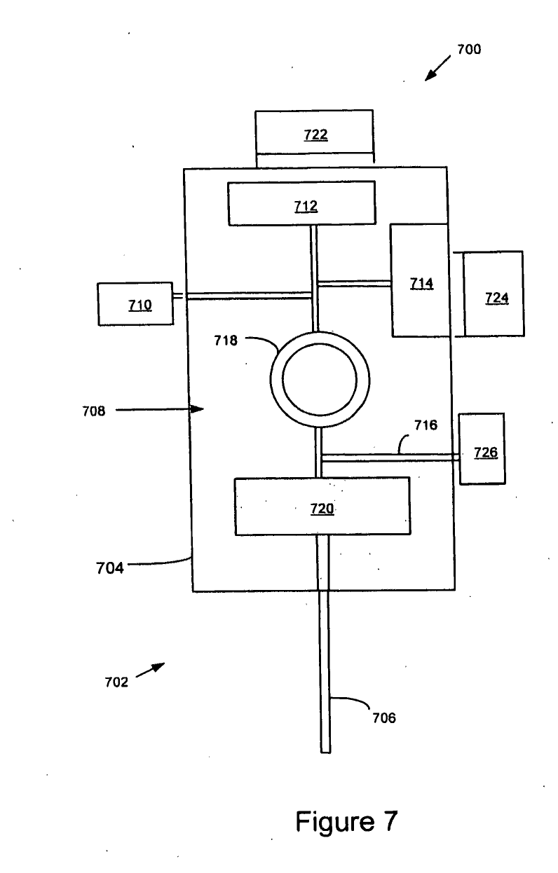

FIG. 7 is a schematic illustration of a microfluidic system 700 according to another embodiment of the current invention. The microfluidic system 700 includes a microfluidic device 702 which can include a microfluidic mixer 704 and a sample storage component 706 that is in fluid connection with the microfluidic mixer 704. The microfluidic mixer 704 includes a mixing section 708, a target molecule input section 710 that is in fluid connection with said mixing section 708, a first reagent input section 712 that is in fluid connection with said mixing section 708, a second reagent input section 714 that is in fluid connection with said mixing section 708, and a neutral fluid input section 716 that is in selectable fluid connection with said sample storage component 706. The target molecule input section 710 is suitable to provide a fluid into the mixing section 708 that contains molecules to be targeted by chemical reactions. For example, the target molecule input section 710 can include one or more microfluidic channels that are structured to be connected to externals sources of fluids containing target molecules. The first reagent input section 712 is structured to selectively provide a first reagent selected from a plurality of reagents to said mixing section to test chemical reactions with the target molecules. For example, the first reagent input section 712 can include a plurality of microfluidic channels to selectively direct fluid from a first reagent source to the mixing section 708. The second reagent input section 714 is structured to selectively provide a second reagent selected from a plurality of reagents to said mixing section 708 to test chemical reactions with the target molecules and the first reagent. The second reagent input section 714 can include a plurality of microfluidic channels to selectively direct fluid from a second reagent source to the mixing section 708.

The neutral fluid input section 716 is structured to selectively provide a neutral fluid into said sample storage component between successive samples provided to the sample storage component to separate successive samples in a stratified arrangement. The neutral fluid input section 716 can include one or more microfludic channels that are constructed to be fluidly connected to a source of neutral fluid. For example, the neutral fluid can be, but is not limited to, perfluoro oil.

The sample storage component 706 can be a storage tube, for example, that can be selectively attached to and detached from the microfluidic mixer 708. For example, a TEFLON tube has been found to be suitable for some applications for the sample storage component 706. The mixing section 708 can include a rotary mixer 718 and a chaotic mixer 720 in some embodiments of the current invention. The arrangement of the target molecule input section 710, the first reagent input section 712, the second reagent input section 714, and the neutral fluid input section 716 in FIG. 7 is schematic only. The sections do not have to be arranged as shown and do not have to be localized as shown. For example, the first reagent input section 712 and the second reagent input section 714 can each have a large number of selectively controllable microfluidic channels that can be arranged in more that one isolated section of the microfluidic device 702 and can even have some interleaving channels, for example.

The microfluidic system 700 can also include a source of a plurality of first reagents 722 in fluid connection with the first reagent input section 712, and a source of a plurality of second reagents 724 in fluid connection with the second reagent input section 714 of the microfluidic mixer 704. The source of a plurality of first reagents 722 can provide a plurality of azide fragments in an embodiment of the current invention. The source of a plurality of second reagents 724 can provide a plurality of acetylene fragments for click chemistry reactions between the first and second reagents and the target molecule according to an embodiment of the current invention.

The neutral fluid input section 716 is shown connecting between the rotary mixer 718 and a chaotic mixer 720 in the example of FIG. 7. However, the invention is not limited to only such an arrangement. For example the neutral fluid input section 716 is can be connected down stream from the chaotic mixer 720 in other embodiments of the current invention. The microfluidic system 700 can also include a source of a neutral fluid 726 in fluid connection with the neutral fluid input section 716 according to an embodiment of the current invention.

The rotary mixer 718 can have a volume within the range of from about 5 mL to about 12500 mL according to some embodiments of the current invention. The rotary mixer 718 can have a volume a volume within the range of from about 25 mL to about 2500 mL according to some embodiments of the current invention. In addition, the rotary mixer 718 can have a volume of about 250 mL according to some embodiments of the current invention.

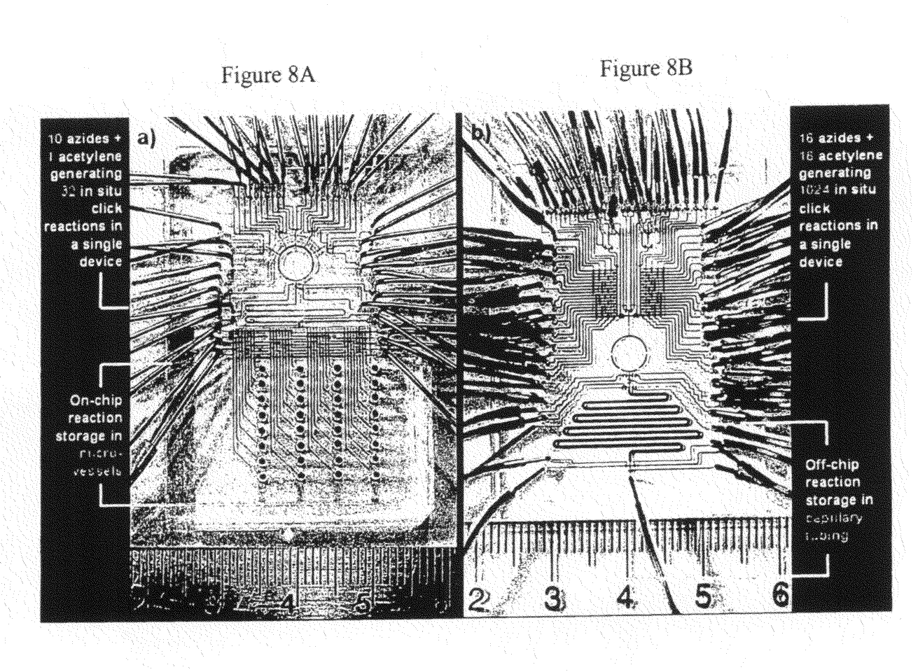

FIGS. 8A and 8B show examples of two microfluidic devices according to embodiments of the current invention. FIG. 88 is an example corresponding to the embodiment of FIG. 7. Note that in this embodiment, the multiplexers 22 and 322 of other embodiments are not required. Furthermore, the sample storage component 706 obviates the need for individual storage chambers thus permitting the microfluidic system 700 to be able to accommodate very large numbers of combinations of reagents with target molecules, for example, for click chemistry reactions.

All references cited herein are incorporated by reference as if each had been individually incorporated. The embodiments illustrated and discussed in this specification are intended only to teach those skilled in the art the best way known to the inventors to make and use the invention. Figures are not drawn to scale. In describing embodiments of the invention, specific terminology is employed for the sake of clarity. However, the invention is not intended to be limited to the specific terminology so selected. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A microfluidic system, comprising:
a microfluidic mixer; and
a sample storage component that is in fluid connection with said microfluidic mixer;
wherein said microfluidic mixer comprises:
a mixing section,
a target molecule input section that is in fluid connection with said mixing section, said target molecule input section being suitable to provide a fluid into said mixing section that contains molecules to be targeted by chemical reactions,
a first reagent input section that is in fluid connection with said mixing section, said first reagent input section being structured to selectively provide a first reagent selected from a plurality of reagents to test a chemical reaction with said target molecules,
a second reagent input section that is in fluid connection with said mixing section, said second reagent input section being structured to selectively provide a second reagent selected from a plurality of reagents to test a chemical reaction with said target molecules and said first reagent, and
a neutral fluid input section that is in selectable fluid connection with said sample storage component, said neutral fluid input section being structured to selectively provide a neutral fluid into said sample storage component between successive samples provided to said sample storage component to separate successive samples in a stratified arrangement.

2. A microfluidic system according to claim 1, wherein said sample storage component is a storage tube that can be selectively attached to and detached from said microfluidic mixer.

3. A microfluidic system according to claim 1, wherein said mixing section comprises a rotary mixer.

4. A microfluidic system according to claim 3, wherein said mixing section comprises a chaotic mixer.

5. A microfluidic system according to claim 1, wherein said first and second input reagent sections each comprise at least ten selectable input channels to permit a selection among at least ten first reagents and at least ten second reagents to provide at least one hundred selectable combinations of the first and second reagents.

6. A microfluidic system according to claim 1, further comprising a source of a plurality of first reagents in fluid connection with said first reagent input section of said microfluidic mixer, and a source of a plurality of second reagents in fluid connection with said second reagent input section of said microfluidic mixer.

7. A microfluidic system according to claim 6, wherein said plurality of first reagents provide a plurality of azide fragments and said plurality of second reagents provide a plurality of acetylene fragments for click chemistry reactions between said first and second reagents and said target molecule.

8. A microfluidic system according to claim 1, further comprising a source of a neutral fluid in fluid connection with said neutral fluid input section of said microfluidic mixer.

9. A microfluidic system according to claim 7, further comprising a source of a neutral fluid in fluid connection with said neutral fluid input section of said microfluidic mixer.

10. A microfluidic system according to claim 9, wherein said source of neutral fluid is a perfluoro oil.

11. A microfluidic system according to claim 3, wherein said rotary mixer has a volume within the range of from about 5 mL to about 12500 mL.

12. A microfluidic system according to claim 3, wherein said rotary mixer has a volume within the range of from about 25 mL to about 2500 mL.

13. A microfluidic system according to claim 3, wherein said rotary mixer has a volume of about 250 mL.

14. A microfluidic device, comprising:
a microfluidic mixer; and
a sample storage component that is in fluid connection with said microfluidic mixer;
wherein said microfluidic mixer comprises:
a mixing section,
a target molecule input section that is in fluid connection with said mixing section, said target molecule input section being suitable to provide a fluid into said mixing section that contains molecules to be targeted by chemical reactions,
a first reagent input section that is in fluid connection with said mixing section, said first reagent input section being structured to selectively provide a first reagent selected from a plurality of reagents to test a chemical reaction with said target molecules,
a second reagent input section that is in fluid connection with said mixing section, said second reagent input section being structured to selectively provide a second reagent selected from a plurality of reagents to test a chemical reaction with said target molecules and said first reagent, and
a neutral fluid input section that is in selectable fluid connection with said sample storage component, said neutral fluid input section being structured to selectively provide a neutral fluid into said sample storage component between successive samples provided to said sample storage component to separate successive samples in a stratified arrangement.

15. A microfluidic device according to claim 14, wherein said sample storage component is a storage tube that can be selectively attached to and detached from said microfluidic mixer.

16. A microfluidic device according to claim 14, wherein said mixing section comprises a rotary mixer.

17. A microfluidic device according to claim 16, wherein said mixing section comprises a chaotic mixer.

18. A microfluidic device according to claim 14, wherein said first and second input reagent sections each comprise at least ten selectable input channels to permit a selection among at least ten first reagents and at least ten second reagents to provide at least one hundred selectable combinations of the first and second reagents.

19. A microfluidic device according to claim 16, wherein said rotary mixer has a volume within the range of from about 5 mL to about 12500 mL.

20. A microfluidic device according to claim 16, wherein said rotary mixer has a volume within the range of from about 25 mL to about 2500 mL.

21. A microfluidic device according to claim 16, wherein said rotary mixer has a volume of about 250 mL.

22. A method of identifying molecules that have a predetermined reaction with a target molecule, comprising:
providing a fluid containing target molecules in a microfluidic mixer;
providing a first reagent from a plurality of available first reagents in said microfluidic mixer along with said target molecules;
providing a second reagent from a plurality of available second reagents in said microfluidic mixer along with said target molecules and said first reagent;
mixing said first reagent, said second reagent and said fluid containing said target molecules to obtain an at least partially mixed sample;
directing said at least partially mixed sample into a sample storage component;
directing a neutral fluid into said sample storage component after said directing said at least partially mixed sample into said sample storage component has been completed to provide a separation layer for protecting said at least partially mixed sample from contamination from subsequent samples to be directed into said sample storage component.

23. A method of identifying molecules that have a predetermined reaction with a target molecule according to claim 22, further comprising repeating said providing a fluid containing target molecules, said providing a first reagent, said providing a second reagent, said mixing said first reagent, said second reagent and said fluid containing said target molecules, said directing said at least partially mixed sample into said sample storage component, and said directing said neutral fluid into said sample storage component a plurality of times to obtain a plurality of samples in said storage component separated by said neutral fluid in a stratified type arrangement.

24. A method of identifying molecules that have a predetermined reaction with a target molecule according to claim 23, wherein said repeating is repeated at least one hundred times with different combinations of said first and second reagents which are selectively provided to said microfluidic mixer.

25. A method of identifying molecules that have a predetermined reaction with a target molecule according to claim 23, wherein said repeating is repeated at least one thousand times with different combinations of said first and second reagents which are selectively provided to said microfluidic mixer.

26. A method of identifying molecules that have a predetermined reaction with a target molecule according to claim 23, further comprising performing mass spectrometry on said plurality of samples in said storage component.

27. A method of identifying molecules that have a predetermined reaction with a target molecule according to claim 22, wherein said at least partially mixed sample has a volume of from about 0.1 μL to about 80 μL.

28. A method of identifying molecules that have a predetermined reaction with a target molecule according to claim 22, wherein said at least partially mixed sample has a volume of from about 1 μL to about 16 μL.

29. A method of identifying molecules that have a predetermined reaction with a target molecule according to claim 22, wherein said at least partially mixed sample has a volume of about 4 μL.
